(19) United States
(12) Patent Application Publication
(10) Pub. No.: US 2022/0055516 A1
(43) Pub. Date: Feb. 24, 2022

(54) GRILL FOR A SEMI-TRACTOR

(71) Applicant: Raul Cordoneda, Hialeah, FL (US)

(72) Inventor: Raul Cordoneda, Hialeah, FL (US)

(21) Appl. No.: 17/000,305

(22) Filed: Aug. 22, 2020

(51) Int. Cl. B60N 3/16; B60P 3/36; B60R 11/00; A47J 37/07; A47J 36/10

(52) U.S. Cl. CPC B60N 3/16; B60P 3/36; A47J 36/10; A47J 37/0713; A47J 37/0786; B60R 11/00

(57) ABSTRACT

A grill for a semi-tractor. The grill has a housing and a lid. The grill has two gas burner assemblies, a gas hose system, a gas regulator system, a cutting board, a drip pan and a utensil holder. The grill has two cooking surfaces. The grill has a bracket assembly system that allows it to be securely attached to a chassis of a semi-tractor. The grill is fueled by using portable gas tanks. The grill allows truck drivers to cook their own food while conducting long truck hauls.

### TECHNICAL FIELD

The present invention pertains to a grill that is mounted on a chassis of a semi-tractor.

### BACKGROUND

The present invention is directed to providing a driver of a semi-tractor the ability to grill his own food while undertaking cross country hauls.

The present Covid-19 outbreak caused the inventor of the present invention to conceive the invention.

Drivers are force to be on the road for extended periods of time and presently it has become dangerous for drivers to eat while conducting hauls. It is like a Russian Roulette, he, being a driver, realized that he has no control of where he is forced to eat while on hauls.

He knows that some drivers take small grills with them to cook while on hauls, yet the grills must be stowed after their use and they also bring unpleasant odors into the cabs of the semi-tractors. He also realized that besides having to bring the portable grills into the semi-tractors, the utensils also must be stowed.

The grill of the present invention is permanently mounted on the chassis of the semi-tractor and serves as a storage compartment for the utensils used to cook on the grill.

The present invention is a grill that does not have to be stowed within the cab of a semi-tractor after use and that can be used to store the utensils needed to cook food on the grill.

### SUMMARY

The present invention is directed to a grill that is attached to the chassis of a semi-tractor.

The grill has a housing and a lid. The grill has two gas burner assemblies, a gas hose system, a gas regulator system, a cutting board, a drip pan and a utensil holder. The grill has two cooking surfaces. The grill has a bracket assembly system that allows it to be securely attached to a chassis of a semi-tractor. The grill is fueled by using portable gas tanks. The grill allows truck drivers to cook their own food while conducting long truck hauls.

An object of the present invention is to provide a grill that attaches to the chassis of a semi-tractor.

Another object of the present invention is to provide a grill that has an internal storage compartment for housing utensils.

Yet another object of the present invention is to provide a grill that has an internal cutting board.

### DRAWINGS

These and other features, aspects, and advantages of the present invention will become better understood with regards to the following description, appended claims, and drawings where:

FIG. 1 is a perspective view of the present invention;

FIG. 2 is a front perspective view of the present invention;

FIG. 3 is a front perspective view of the present invention wherein the L-shaped top is off the seven-sided grill frame; and

FIG. 4 is a rear perspective of the present invention.

### DESCRIPTION

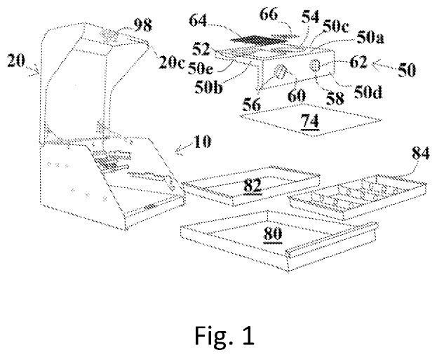

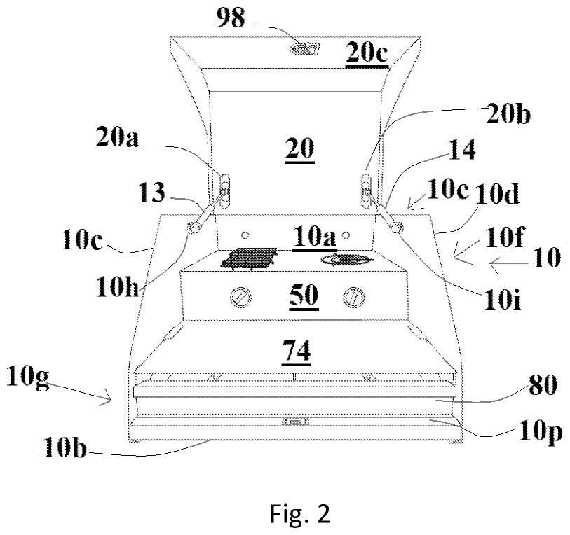

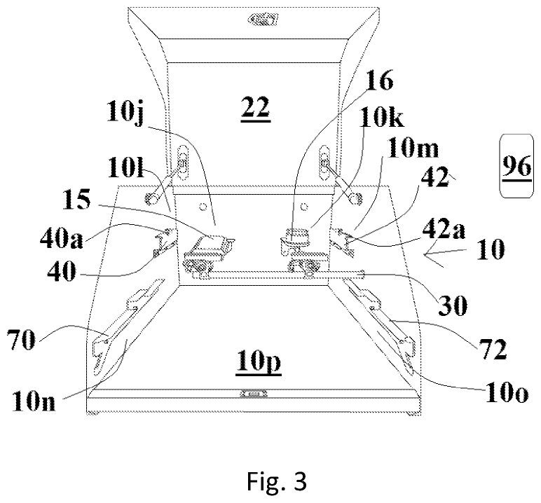

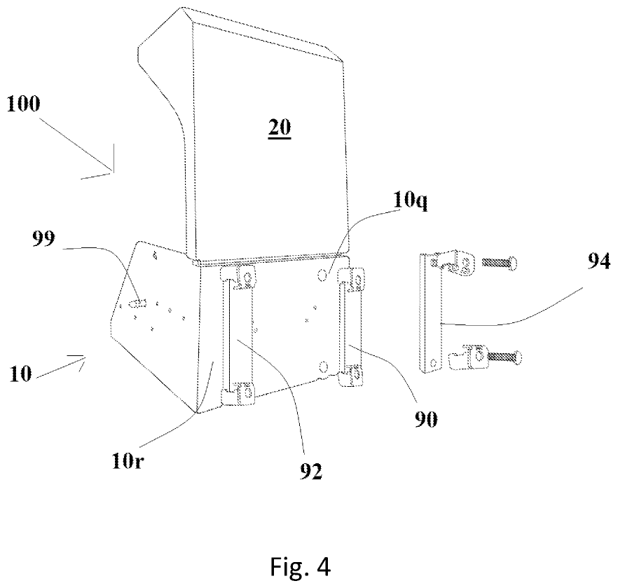

Referring to FIGS. 1-4, the present invention is a grill 100 that attaches to a semi-tractor. The grill comprises a seven-sided grill frame 10 that has a rear side 10a, a bottom side 10b, a left side 10c and a right side 10d, an open top side 10e, an open front diagonal side 10f and an open front side 10g. A lid 20 that attaches to the seven-side grill frame 10 via a swivel 12. A left shock absorber 13 and a right shock absorber 14, the left shock absorber 13 attaches to a left inner part of the lid 20a and to a left inner part 10h of the seven-side grill frame 10, the right shock absorber 14 attaches to a right inner part of the lid 20b and to a right inner part 10i of the seven sided grill frame 10. A left gas burner assembly 15 that is attached to a left inner rear side 10j of the seven-sided grill 10 and a right gas burner assembly 16 that is attached to a right inner rear side 10k of the seven-sided grill 10, a gas line 30 that attaches to the left gas burner assembly 15 and to the right gas burner assembly 16, the gas line 30 attaches to a portable gas source 96. A left top rail 40 that is mounted on a left rear inner side 101 of the left side 10c of the seven-sided frame 10 and a right top rail 42 that is mounted on a right rear inner side 10m of the right side 10d of the seven-sided frame 10. An L-shaped top 50 that has a top side 50a, a left side 50b, a right side 50c and a front side 50d, the top side 50a defines a left top aperture 52 and a right top aperture 54, the front side 50d defines a left front aperture 56 and a right front aperture 58, the left side 50b of the L-shaped top 50 and right side 50c of the L-shaped top 50 define a catch 50e that falls on a latch 40a and 42a of the left top rail 40 and the right top rail 42, the L-shaped top 50 is secured on the left top rail 40 and the right top rail 42. A left regulator 60 that is attached to the line 30 that feeds the left gas burner assembly 15, the left regulator 60 extends outward from the left front aperture 56 of the L-shaped top 50, and a right regulator 62 that is attached to the line 30 that feeds the right gas burner assembly 16, the right regulator 62 extends outward from the right front aperture 58 of the L-shaped top 50. A grill grate 64 that is place above the left top aperture 52 of the L-shaped top 50, and a right burner grate 66 that is placed above the right top aperture 54 of the L-shaped top 50. A left bottom rail 70 that is mounted on a left front inner side 10n of the left side 10c of the seven-sided frame 10 and a right bottom rail 72 that is mounted on a right front inner side 10o of the right side 10d of the seven-sided frame 10, a cutting board 74 is placed above the left bottom rail 70 and the right bottom rail 72. A drawer 80, a divider 82 that houses a utensil organizer 84 that is placed in the drawer 80, the drawer is place on the inner bottom side 10p of the seven-sided grill frame 10. And, a left bracket assembly 90 and a right bracket assembly 92, the left bracket assembly 90 attaches to the left outer rear side 10q of the seven-sided grill 10 and the right bracket assembly 92 attaches to the right outer rear side 10r of the seven-sided grill 10, the left side bracket assembly 90 and the right bracket assembly 92 attach to a chassis 94 of the semi-tractor.

In an embodiment of the present invention, the grill comprises of a portable gas source 96.

In another embodiment of the present invention, the grill comprises of a utensil organizer 84.

In yet another embodiment of the present invention, the grill comprises of a lock assembly 98, the lock assembly is placed on a front side of the lid 20c, the lock assembly locks the lid 20 to the seven-sided grill frame 10.

In still a further embodiment of the present invention, the grill comprises of a fitting 99 that attaches to the portable gas hose 30.

An advantage of the present invention is that it provides a grill that attaches to the chassis of a semi-tractor.

Another advantage of the present invention is that it provides a grill that has an internal storage compartment for housing utensils.

Yet another advantage of the present invention is that it provides a grill that has an internal cutting board.

The embodiments of the grill described herein are exemplary and numerous modifications, combinations, variations, and rearrangements can be readily envisioned to achieve an equivalent result, all of which are intended to be embraced within the scope of the appended claims. Further, nothing in the above-provided discussions of the grill should be construed as limiting the invention to an embodiment or a combination of embodiments. The scope of the invention is defined by the appended claims.

1. A grill for a semi-tractor, the grill comprises:
a seven-sided grill frame that has a rear side, a bottom side, a left side and a right side, an open top side, an open front diagonal side and an open front side;
a lid that attaches to the seven-sided grill frame via a swivel;
a left and a right shock absorber, the left shock absorber attaches to a left inner part of the lid and to a left inner part of the seven-sided grill frame, the right shock absorber attaches to a right inner part of the lid and to a right inner part of the seven-sided grill frame;
a left gas burner assembly that is attached to a left inner rear side of the seven-sided grill frame and a right gas burner assembly that is attached to a right inner rear side of the seven-sided grill frame, a gas line that attaches to the left gas burner assembly and to the right gas burner assembly, the gas line attaches to a portable gas source;
a left top rail that is mounted on a left rear inner side of the left side of the seven-sided grill frame and a right top rail that is mounted on a right rear inner side of the right side of the seven-sided grill frame;
an L-shaped top that has a top side, a left side, a right side and a front side, the top side defines a left top aperture and a right top aperture, the front side defines a left front aperture and a right front aperture, the left side of the L-shaped top and right side of the L-shaped top define a catch that falls on a latch of the left top rail and the right top rail, the L-shaped top is secured on the left top rail and the right top rail;
a left regulator that is attached to the line that feeds the left gas burner assembly, the left regulator extends outward from the left front aperture of the L-shaped top, and a right regulator that is attached to the line that feeds the right gas burner assembly, the right regulator extends outward from the right front aperture of the L-shaped top;
a grill grate that is placed above the left top aperture of the L-shaped top, and a right burner grate that is placed above the right top aperture of the L-shaped top;
a left bottom rail that is mounted on a left front inner side of the left side of the seven-sided grill frame and a right bottom rail that is mounted on a right front inner side of the right side of the seven-sided grill frame, a cutting board attaches to the top of the left bottom rail and the right bottom rail;
a drawer, a rectangular utensil housing 82 that houses a utensil organizer 84, the rectangular utensil housing 82 is placed in the drawer 80, the drawer 80 is placed on the inner bottom side of the seven-sided grill frame; and
a left bracket assembly and a right bracket assembly, the left bracket assembly attaches to the left outer rear side of the seven-sided grill frame and the right bracket assembly attaches to the right outer rear side of the seven-sided grill frame, the left side bracket assembly and the right bracket assembly are configured to attach to a chassis of the semi-tractor.

2. The grill for a semi-tractor of claim 1, the grill comprises a portable gas source.

3. The grill for a semi-tractor of claim 1, the grill comprises a utensil organizer.

4. The grill for a semi-tractor of claim 1, the grill comprises a lock assembly, the lock assembly is placed on a front side of the lid, the lock assembly locks the lid to the seven-sided grill frame.

5. The grill for a semi-tractor of claim 1, the grill comprises a fitting that attaches to the portable gas source.
